(19) United States
(12) Patent Application Publication
(10) Pub. No.: US 2014/0365023 A1
(43) Pub. Date: Dec. 11, 2014

(54) Systems and Methods for Computer Implemented Energy Management

(71) Applicant: SAP AG, Walldorf (DE)

(72) Inventors: Holger Kiefhaber, Karlsruhe (DE); Frank Eichinger, Karlsruhe (DE)

(21) Appl. No.: 13/914,364

(22) Filed: Jun. 10, 2013

(51) Int. Cl. G06Q 50/06

(52) U.S. Cl. CPC G06Q 50/06
USPC 700/291

(57) ABSTRACT

In one embodiment the present invention includes a computer-implemented method comprising receiving energy information indicating an excess or deficiency of available energy for consumption by an energy consumer during a particular time period, generating energy utilization scenarios, where each energy utilization scenario models how energy is consumed by energy utilization systems under control of the energy management application over the time period, generating cost data based on each of the one or more energy utilization scenarios; and generating reconfiguration instructions to reconfigure one or more of the energy utilization systems to increase or decrease energy use by the energy consumer.

### BACKGROUND

The present invention relates to computing and data processing, and in particular, to systems and methods for computer implemented energy management.

The increasing use of renewable energy is creating challenges for existing energy distribution systems, such as electricity grids. It is typically desirable that electricity grids are stable and allow consumers to receive any amount of desired energy at any point in time. This requires that electricity systems have to constantly maintain a balance between demand and supply. However, renewable energy sources are often an unsteady and fluctuating source of energy. The production of photovoltaic or wind energy does not necessarily match the energy demand patterns of consumers, but rather, depends on variable and often unpredictable conditions relating to weather, for example. Compensation for the fluctuating nature of renewables has been attempted, but such solutions often lead to inefficiencies and high costs. For example, flexible gas turbines that are permanently held in stand-by operation have been considered to compensate for varying amounts of energy from renewables. However, such stand-by operation is highly inefficient. Other compensation approaches include energy storage solutions, but these solutions are inefficient and costly.

Another growing problem with renewable energy is the distributed nature of renewable energy sources. Solar and wind power may be generated by large arrays of energy production units (e.g., solar cells or wind turbines) that may be spread out across large geographic areas. However, many contemporary electricity systems have been designed for more central energy generation with a comparably small number of large power plants. Much of today's grid infrastructure is built on the understanding and technology that power flows from higher to lower voltage levels, for example. In contrast, distributed generation units operate at different voltage levels, which can potentially result in bidirectional power flow within the grid. Issues arise, for instance, when photovoltaic panels installed on many roofs in a certain neighborhood feed their electricity into the local low-voltage distribution grid. These grids might then temporarily have a surplus of energy which possibly cannot be transported to other regions across higher grid levels.

### SUMMARY

Embodiments of the present invention improve energy management. In one embodiment, the present invention includes a computer-implemented method comprising receiving, in a computer executing an energy management application, energy information indicating an excess or deficiency of available energy for consumption by an energy consumer during a particular time period, generating, in the computer executing the energy management application, one or more energy utilization scenarios, wherein each energy utilization scenario models how energy is consumed by one or more energy utilization systems under control of the energy management application over said time period, generating, in the computer executing the energy management application, cost data based on each of the one or more energy utilization scenarios, and generating reconfiguration instructions, in the computer executing the energy management application, to reconfigure one or more of the energy utilization systems to increase or decrease energy use by the energy consumer.

In one embodiment, different energy utilization systems have different cost models, and wherein particular configurations of a particular energy utilization system are automatically translated into cost data for a particular cost model associated with the particular energy utilization system.

In one embodiment, the method further comprises displaying the energy utilization systems to a user, receiving a selection of a particular energy utilization system, accessing control parameters for the particular energy utilization system, receiving modifications to the control parameters from a user, and generating cost data, based on the modifications to the control parameters, for a particular cost model for the particular energy utilization system, wherein the cost data represents a cost associated with a change in energy consumption by the energy consumer caused by the modifications to the control parameters.

In one embodiment, the received energy information indicates a particular amount of additional available energy during the particular time period, and wherein the particular amount of additional available energy is allocated across a plurality of said energy utilization systems, and wherein each energy utilization system has an associated additional energy consumption and net cost, wherein additional energy consumption and net cost of the energy utilization systems are aggregated to produce a total additional energy that is greater than or equal to said particular amount of additional available energy and an associate total cost.

In one embodiment, the method further comprises sending a message to an energy provider offering to consume the additional available energy.

In one embodiment, the received energy information indicates a reduction in available energy during the particular time period, the method further comprising retrieving, in a computer executing an energy management application, data corresponding to a plurality of activities, the data indicating an amount of energy consumed by each of the plurality of activities and a time period associated with each of the plurality of activities, sending the data for display to a user, and receiving a selection of one or more of said activities and a change in the time period associated with the selected activities to change the time period when particular activities consume energy.

In another embodiment, the present invention includes a system comprising one or more processors and a non-transitory computer readable medium having stored thereon program code, which when executed by the processor, causes the processor to receive energy information indicating an excess or deficiency of available energy for consumption by an energy consumer during a particular time period, generate one or more energy utilization scenarios, wherein each energy utilization scenario models how energy is consumed by one or more energy utilization systems under control of the energy management application over said time period, generating cost data based on each of the one or more energy utilization scenarios, and generating reconfiguration instructions to reconfigure one or more of the energy utilization systems to increase or decrease energy use by the energy consumer.

In one embodiment, different energy utilization systems have different cost models, and wherein particular configurations of a particular energy utilization system are automatically translated into cost data for a particular cost model associated with the particular energy utilization system.

In one embodiment, the program code further causes the processor to display the energy utilization systems to a user, receive a selection of a particular energy utilization system, access control parameters for the particular energy utilization system, receive modifications to the control parameters from a user, and generate cost data, based on the modifications to the control parameters, for a particular cost model for the particular energy utilization system, wherein the cost data represents a cost associated with a change in energy consumption by the energy consumer caused by the modifications to the control parameters.

In one embodiment, the received energy information indicates a particular amount of additional available energy during the particular time period, and wherein the particular amount of additional available energy is allocated across a plurality of said energy utilization systems, and wherein each energy utilization system has an associated additional energy consumption and net cost, wherein additional energy consumption and net cost of the energy utilization systems are aggregated to produce a total additional energy that is greater than or equal to said particular amount of additional available energy and an associate total cost.

In one embodiment, the program code further causes the processor to send a message to an energy provider offering to consume the additional available energy.

In one embodiment, the received energy information indicates a reduction in available energy during the particular time period, wherein the program code further causes the processor to retrieve, in a computer executing an energy management application, data corresponding to a plurality of activities, the data indicating an amount of energy consumed by each of the plurality of activities and a time period associated with each of the plurality of activities, send the data for display to a user, and receive a selection of one or more of said activities and a change in the time period associated with the selected activities to change the time period when particular activities consume energy.

In another embodiment, the present invention includes a non-transitory computer readable storage medium embodying a computer program for performing a method, said method comprising receiving energy information indicating an excess or deficiency of available energy for consumption by an energy consumer during a particular time period, generating one or more energy utilization scenarios, wherein each energy utilization scenario models how energy is consumed by one or more energy utilization systems under control of the energy management application over said time period, generating cost data based on each of the one or more energy utilization scenarios, and generating reconfiguration instructions to reconfigure one or more of the energy utilization systems to increase or decrease energy use by the energy consumer.

The following detailed description and accompanying drawings provide a better understanding of the nature and advantages of the present invention.

### BRIEF DESCRIPTION OF THE DRAWINGS

FIG. 1 illustrates a system including computer implemented energy management according to one embodiment.

FIG. 2 illustrates receiving an energy tender and response according to one embodiment.

FIG. 3 illustrates a computer process for simulating energy use according one embodiment.

FIG. 4 illustrates a computer process for simulating energy use in response to an energy tender according another embodiment.

FIG. 5A illustrates a configuration of computers and energy systems according an example embodiment.

FIG. 5B illustrates a user interface for simulating energy use based on available energy according an example embodiment.

FIG. 6A illustrates a configuration of computers and energy systems according another example embodiment.

FIGS. 6B-D illustrate user interfaces for simulating energy use based on available energy according another example embodiment.

FIG. 7 illustrates an example of energy data in an energy management application according to another embodiment.

FIG. 8 illustrates hardware of a special purpose computing machine configured with a process according to one embodiment of the present invention.

### DETAILED DESCRIPTION

Described herein are techniques for energy management. The apparatuses, methods, and techniques described below may be implemented as a computer program (software) executing on one or more computers. The computer program may further be stored on a tangible non-transitory computer readable medium, such as a memory or disk, for example. A computer readable medium may include instructions for performing the processes described below. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

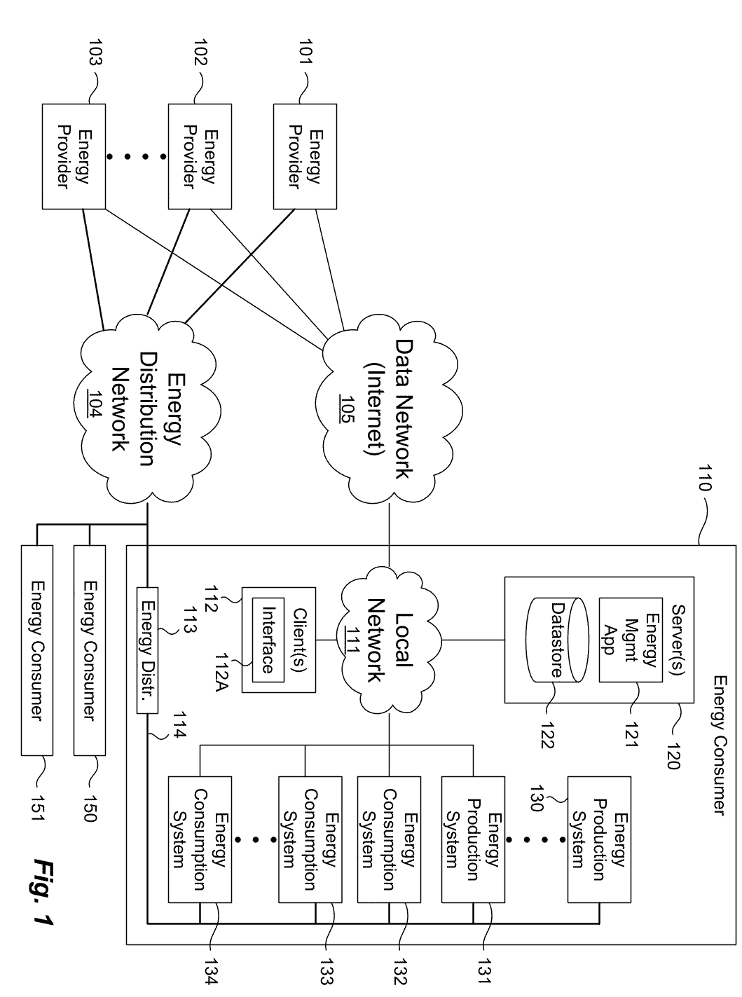

FIG. 1 illustrates a system including computer implemented energy management according to one embodiment. Energy providers 101-103 may provide energy through an energy distribution network 104 (e.g., an electricity grid) to energy consumers 110, 150, and 151. Energy providers 101-103 may also communicate with energy consumers 110, 150, and 151 over a data network 105 (e.g., the Internet). Energy providers may include direct and indirect providers of energy, such as energy producers (e.g., power plants), utility companies, or energy retailers, for example. Energy consumers may include large or small organizations having manufacturing or operational facilities, industrial facilities, commercial office buildings, government agency facilities, or other facilities in a single location or multiple locations that use energy to operate their systems.

An example energy consumer 110 may receive energy in an energy distribution system 113 and transmit the energy to a variety of systems across an energy distribution infrastructure 114. Energy distribution infrastructure 114 may include electrical cables carrying voltage and current, for example. Energy distribution infrastructure 114 may route energy to numerous energy consumption devices 132-134, which may include air conditioning systems, heaters, factory equipment, computer systems, electric vehicle charging systems, and a wide variety of other systems that require energy to operate, for example. Energy distribution infrastructure 114 may route energy from numerous energy generation devices 130-131, which may include localized energy production systems such as a combined heat and power (CHP) system, for example.

Energy providers 101-103 may include computer systems and software for sending and receiving information with energy consumers 110, 150, and 151 over network 105. Energy consumer 110 may receive information from energy provider computers over a local network 111 in one or more servers 120. Features and advantages of the present invention include, but are not limited to, an energy management application 121 that receives information from energy providers and inputs from an “energy manager” (e.g., a user, described below) to shift demand of energy and use available energy more efficiently. Demand shifting (sometimes referred to as “Demand Response”) may facilitate generation-driven demand which can deal with both the fluctuating and distributed nature of renewable energies. Energy management application 121 may include software that executes on one or more servers 120. The system may further include a datastore 122 (e.g., a database) that stores data about energy use as described in more detail below. Users (e.g., an energy manager) may access energy management application 121 on server(s) 120 over local network 111 using one or more local client computers 112, for example. A local client computer 112 may provide an interface 112A for accessing and using functions of the energy management application 121. Users may control and customize the use of available energy from energy providers to take better advantage of the energy available at particular time periods.

Energy management application 121 is further coupled to energy utilization systems 130-134. Energy utilization systems may include systems that consume energy or systems that generate energy, or both. In some example embodiments, energy utilization systems may include hardware for controlling the operation of the systems (e.g., processors, controllers, or a computer system), and the hardware may execute software that may allow remote control of the systems. Accordingly, energy management application 121 may communicate with energy utilization systems 130-134 over network 111 to control the energy consumption or production of the systems, including turning the systems on or off (or to an intermediate energy consumption or production level), for example. Additionally, energy management application 121 may receive energy related data from energy utilization systems 130-134 and store such data in datastore 122. Examples of data that may be stored in datastore 122 are provided below in various example embodiments.

In one example embodiment, energy management application 121 may receive information about available energy and simulate energy utilization scenarios that increase or decrease consumption (e.g., change demand) based on the amount of energy available over a particular time period. Features and advantages of the present invention include generating cost models for different energy utilization scenarios to allow users to determine optimal courses of action when adjusting demand to meet the energy available at particular time periods.

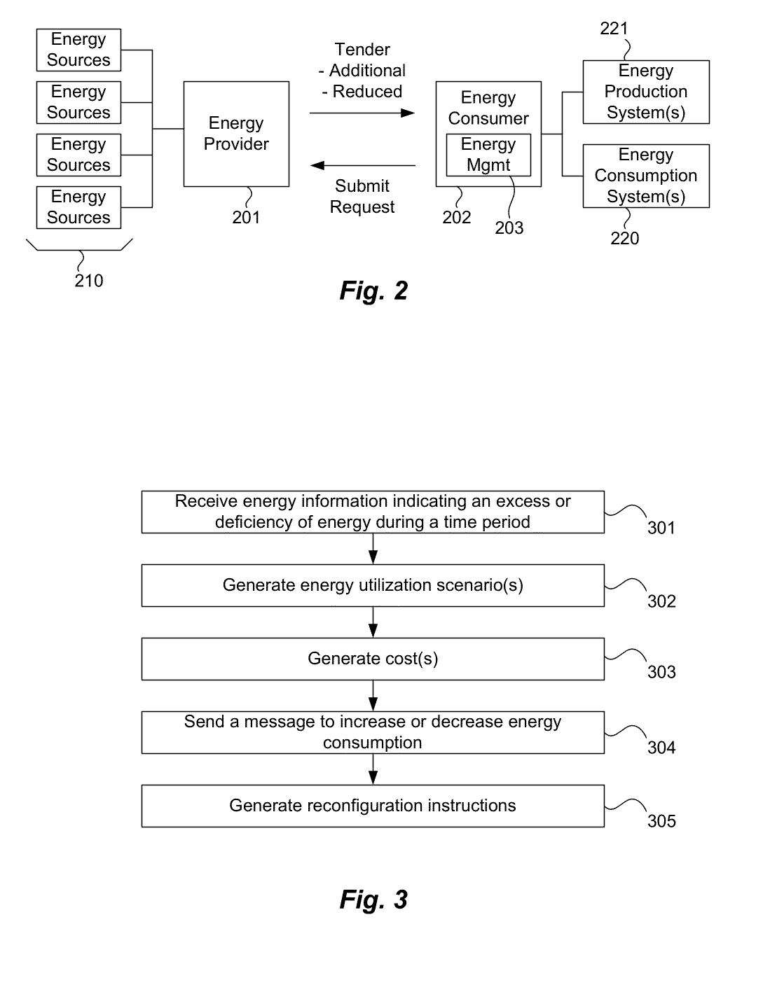

FIG. 2 illustrates receiving an energy tender and a response according to one embodiment. In some embodiments, an energy consumer may have varying amounts of energy available from energy sources. During particular time periods there may be excess energy (e.g., as renewable sources increase output), and during other time periods there may be a deficiency of energy (e.g., as renewable sources decrease output). Excess energy may cause the price of energy to go down either directly or in the form of incentives, such as rebates. Similarly, a deficiency of energy may cause the price of energy to go up. Energy consumers 202 operating a computer implemented energy management application 203 may react dynamically to the availability of energy by reconfiguring their systems to change energy usage during particular time periods and lower the overall cost of energy. In this example, a computer application operated by the energy provider 201 notifies an energy manager at the energy consumer 202 of a change in the availability of energy by sending an energy tender describing the additional energy available (e.g., a surge in wind energy and related rebates) or the deficiency of energy available (e.g., peak loading of a grid and related cost increases). An “energy tender” is a proposal that may be received from an energy provider, for example, to purchase an amount of available energy for a particular price. Example energy tenders are provided below. Energy management application 203 operating on an energy consumer's computer systems may receive the message and simulate energy utilization scenarios that change how energy is consumed by energy consumption systems 220 or energy production systems 221 over said time period so that the total change in energy meets a particular energy value and optimizes energy costs, for example. In particular embodiments, an energy utilization scenario may be used to automatically produce a cost associated with the change in energy use, and the cost may be used as the basis of a transaction to receive additional energy, for example.

FIG. 3 illustrates a computer process for simulating energy use according one embodiment. At 301, energy information indicating an excess or deficiency of energy available from one or more energy providers during a particular time period is received in a computer executing an energy management application, for example. For example, an energy provider may send an energy tender indicating a particular amount of additional available energy from a renewable source (e.g., a wind farm) during a particular time period.

At 302, energy management application 203 may be used to generate one or more energy utilization scenarios. Each energy utilization scenario models how energy is consumed by energy utilization systems under control of the energy management application during the time period. An energy utilization scenario may be a particular group of settings for each of the different energy systems available to the energy management application. In some embodiments, different energy utilization scenarios may be stored in a datastore as a record, where fields of the record designate settings for particular energy systems. The record may include cost information as described below. For example, if an energy provider has a particular amount of excess energy available over a particular time period with an opportunity for an incentive, energy management application 203 may be used to generate energy utilization scenarios that simulate different configurations of energy consumption and production systems. In various embodiments, heating or air conditioning systems may be turned up or down, production systems and usage may be increased or reduced, local energy production systems may be turned on or off, and more generally, the energy footprint of a particular facility may be modified to coincide with available energy, thereby shifting demand and reducing the cost of energy.

At 303, energy management application 203 may generate cost models based on each of the energy utilization scenarios. Cost models may include the following:
costs over the identified time period related to savings from reducing consumption of a particular energy system,
costs over the identified time period related to additional costs from increasing consumption of a particular energy system,
a normal cost indicating the cost of running each energy system if no action were taken to optimize energy use,
costs of turning a system off and/or on, and
other costs related to the particular energy configuration of a particular energy system.
   Costs may be either positive or negative depending on whether additional energy is consumed or saved or depending on the nature of the transaction with the energy provider. Costs may be associated with particular energy systems that may be configured using the energy management application, and for each energy system numerous parameters may be adjusted with numerous cost parameters being changed for different parameter settings. Costs may also be associated with particular energy values. For example, turning off a local generator for 3 hours may be associated with the increased use of 16,446 kWh of available renewable energy, which may be associated with a plurality of different costs that an energy manager may want to review and analyze before making a decision to turn off the local generator and use the available renewable energy. Costs for different configurations of different energy systems may be aggregated into a net cost that is associated with a net increase or decrease in energy for the time period under analysis, for example.

At 304, energy management application may send a message to increase or decrease energy consumption. For example, in one embodiment energy management application may generate a message to the energy provider indicating that the energy consumer desires to receive additional available energy. The message may include a request (or offer) to receive the available energy and receive a particular amount of money that the energy provider must rebate the energy consumer, for example.

At 305, energy management application may generate reconfiguration instructions to reconfigure one or more of the energy utilization systems to increase or decrease energy use by the energy consumer. For example, an energy manager may optimize energy use by configuring multiple systems with particular settings to hit a particular energy goal (e.g., an increase target to consume an available renewable energy source in exchange for a rebate or a decrease target to reduce consumption during a peak cost period). Simulating different scenarios of energy use and cost using the energy management application, the energy manager may select a particular energy utilization scenario with a corresponding cost model to achieve the most cost effective use of energy across a facility. Energy management application 203 then generates and sends reconfiguration instructions to each of the energy systems included in the selected scenario to reconfigure each system's energy use.

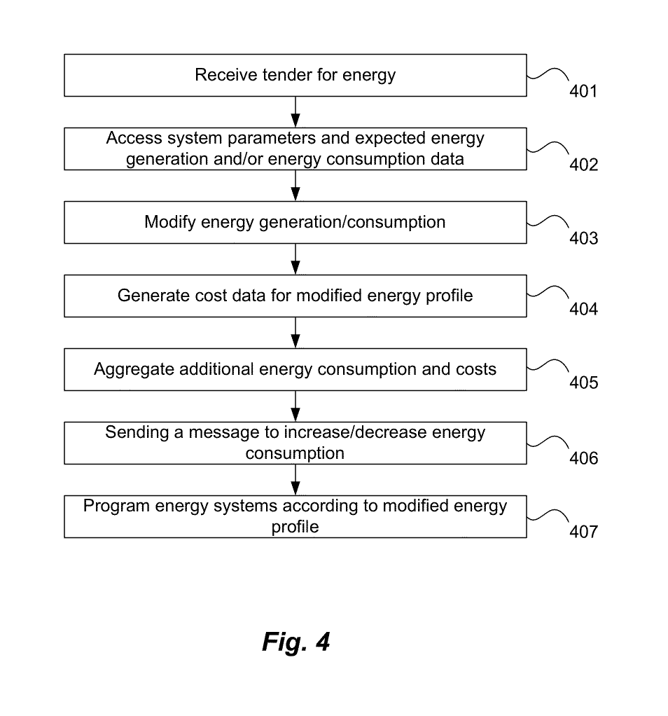

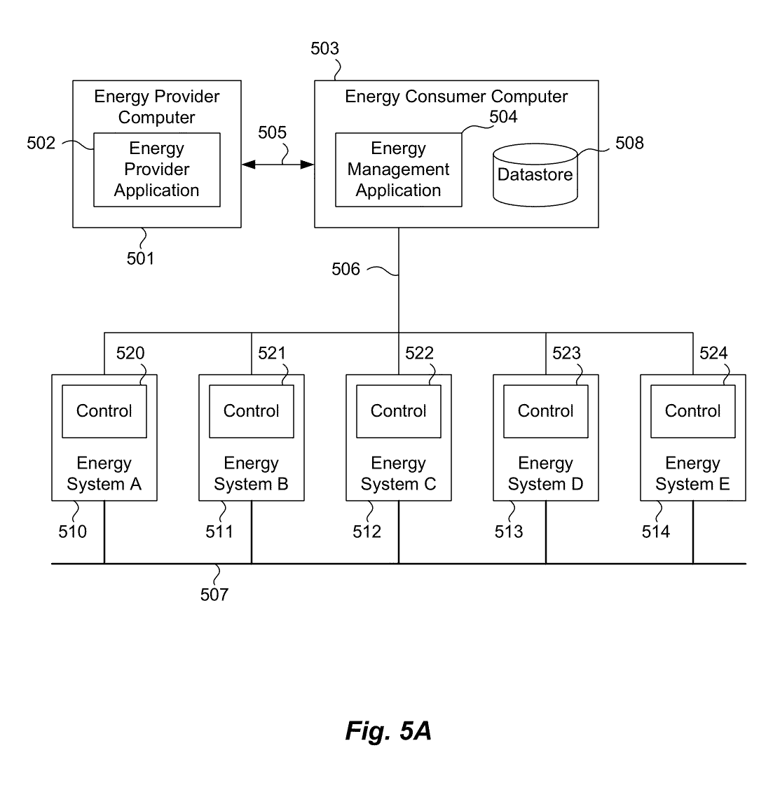

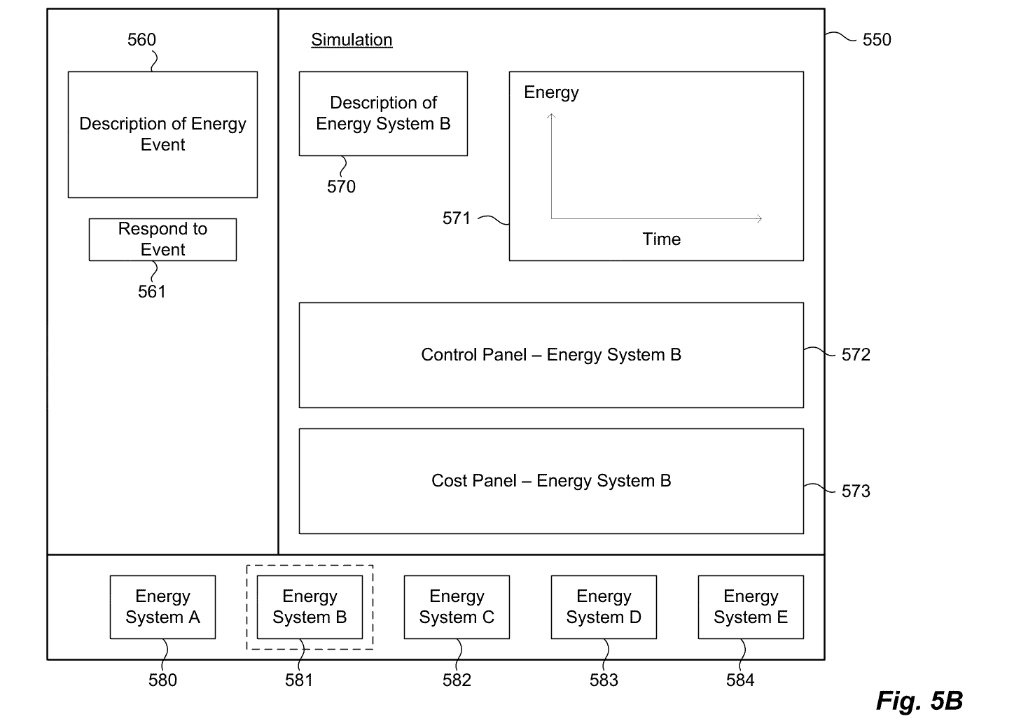

FIG. 4 illustrates a computer process for simulating energy use in response to an energy tender according to another embodiment. In this example, a surplus of renewable energy may be available to an energy provider, and the energy provider may want to incentivize energy consumers to use the additional energy. Example environments where such a transaction may take place include a situation where an energy consumer has an existing contract with an energy provider that designates a particular price of energy during a particular time period (e.g., 10 am to 1 pm). The energy provider may be willing to pay the energy consumer money to use additional available energy from a renewable source (e.g., wind) during the time period. However, the energy consumer may have costs associated with changing their energy use over the time period. Embodiments of an energy management application allow an energy manager to simulate different energy utilization scenarios to determine whether or not, and at what cost, they can offer to consume the additional energy from the energy provider. The computer process illustrated in FIG. 4 is described with further reference to FIGS. 5A-B.

FIG. 5A illustrates a hardware configuration that may be used to implement the process of FIG. 4. An energy provider may have one or more computers 501 that execute a software application 502 that may generate and send messages over a network 505 (e.g., the Internet) to an energy consumer's computer 503. Computer 503 executes an energy management application 504 that may send/receive messages to/from energy provider computer 501. Referring to FIG. 4 at 401, a message including a tender for energy is received in the energy management system. The message may include a description of an amount of excess energy available and a time period (e.g., available kWh, date, a start time, and end time).

At 402, the energy management application may access energy system parameters and energy generation and/or energy consumption data. Referring to FIG. 5A, computer 503 is coupled over data network 506 to multiple energy systems 510-514 that receive and/or send power across energy distribution infrastructure 507. Systems 510-514 may include control blocks 520-524 with hardware and executable software to communicate information between each system and application 504, for example. Computer 503 may include a datastore 508 that receives and stores energy data from each energy system. Energy data may include historical information about the amount of energy each particular system has used over time. Energy data may include compilations of energy values associated with a particular system and an increment of time (e.g., Air Conditioner, 200 kWh, Mar. 1, 2013 from 1:15 pm to 1:30 pm) or data from sensors associated with the energy systems (e.g., Air Conditioning Temp Sensor, 19 Celcius, Mar. 1, 2013 at 2 pm). In addition to historical information, datastore 508 may include projections describing plans for future expected uses of energy for each system, which may be based on the historical information, for example.

FIG. 5B illustrates a user interface that may be generated by a computer system to display information to a user according to an example embodiment. User interface 550 may display a description of an energy event at 560, which may include information in the message from the energy producer about availability of energy (e.g., a surplus amount of energy and time period). A user may respond to the energy event by clicking the “Respond to Event” link after simulating and analyzing the impact of the event on local energy operations as described below, for example. Interface 550 may display the energy systems that may be controlled. In this example, a user may select energy systems A-E (see FIG. 5B) using links 580-584. FIG. 5B illustrates selection of Energy System B 581 as illustrated by the dashed lines around line 581. When selected, particular data for a particular energy system is retrieved (e.g., from datastore 508) and may be presented to the user. Data particular to Energy System B may include a description of Energy System B at 570, energy data for Energy System B at 571 (e.g., historical or planned energy use information over time), available control parameters for Energy System B at 572, and a cost model for Energy System B at 573 with cost data that may be calculated based on the planned use of energy, for example. In one embodiment, the time period specified in the message from the energy provider is used as a component of the query to retrieve planned energy use data for the particular energy system around the time period specified in the message, for example.

Features and advantages of the present invention may include, for example, storing system control parameters for each energy system 510-514 in datastore 508, accessing the parameters using an energy management application, dynamically adjusting some or all of the parameters to meet available energy conditions, and updating a cost model for the particular energy system automatically. Referring again to FIG. 4, at 403, a user may adjust control parameters for a selected energy system using control panel 572 to modify energy generation or consumption, for example. When a user selects a particular energy system, the application may query datastore 508 to retrieve control parameters for the particular system. Control panel 572 may display the control parameters and allow a user to reconfigure particular parameters using a variety of display elements, such as buttons for turning functions ON and OFF, sliders for adjusting values of particular parameters (e.g., temperature), or drop down menus for selecting from lists of options, for example.

In one embodiment, the control parameters for one or more energy systems may define a planned energy use profile over the time period when the energy provider has additional available energy. Energy management application 504 may use some or all of the additional available energy from the energy provider to create a modified energy use profile for a particular energy system over the time period specified in the message from the energy provider. For example, if the energy provider makes a block of energy available to energy consumers, the amount of energy may be received by the energy management application 504 and divided between multiple energy systems 510-514 (e.g., automatically). Energy management application 504 may retrieve planned energy use profiles for each energy system 510-514 and modify the planned energy use profiles to produce modified energy use profiles so that particular amounts of energy from the total energy block are divided (e.g., automatically) across the energy systems 510-514. The modified energy use profiles may define changing energy system parameters over the time period to use a particular portion of the total energy block. Further, portions of the total energy block allocated to particular energy systems may be associated with the particular energy system and used in generating the cost model described below.

At 404, cost data for a modified energy profile is generated. Automatically generated cost data may be displayed to a user in cost panel 573 of FIG. 5B. For example, when the parameters for a particular energy system are changed, energy management application 504 may automatically calculate a plurality of costs associated with the new configuration. Datastore 508 may include energy cost data that transforms each energy system's configuration into associated costs for each element of a cost model. For example, terms of a standard contract with an energy provider may be used to translate a particular systems energy use at a particular time into a cost, which may set a baseline for analyzing the cost benefits of additional available energy from a renewable source. Different energy systems 510-514 may have different cost models stored in datastore 508. For example, an air conditioner may have different operating cost parameters than a particular piece of manufacturing equipment. Cost data elements of a particular cost model may include savings for changing the energy use of the system against historical or planned costs, shutdown costs, startup (or Run up) costs, and a net cost for a particular configuration of a particular system over a particular time period (i.e., the sum of all savings and expenses for a particular energy system over a particular time period). One advantage of the some embodiments is the ability to configure the operation and energy use of one or more energy systems and, for each system, automatically and dynamically update a system specific cost model with cost data corresponding to different user configurations of the system.

Referring again to FIG. 4, at 405, additional energy consumption and costs are aggregated. For example, in one example implementation, energy management application 504 may access the different cost models for different energy systems, as described above, and allocate a portion of a total amount of additional available energy to one or more energy systems. Application 504 may determine net costs for each energy system using the systems associated cost model. The net cost for each energy system is the cost associated with using the allocated portion of additional available energy by that system. Finally, the net costs for each of the energy systems may be aggregated to produce a total cost that is associated with using the total amount of additional available energy from the energy provider. In one embodiment illustrated in an example below, an additional “markup” amount may be automatically included in the total cost. In this example, the total cost of using the total amount of additional available energy from the energy provider is related to an amount the energy provider may pay the energy consumer for using the energy (e.g., as a rebate). Therefore, a markup represents an additional amount of money the energy consumer may desire from the energy provider to use the additional available energy.

At 406, a message may be sent to increase (or decrease) energy consumption. For example, an energy manager using energy management application 504 may send message to an energy provider offering to consume the additional energy if the energy consumer will cover the additional total cost associated with using the additional energy, and optionally a markup. When an energy manager selects the “Respond to Event” link in FIG. 5B, for example, application 504 may automatically generate an electronic message offering to receive the available energy, including legal terms and the total cost (e.g., with markup) generated by reconfiguring energy systems 580-584. Other embodiments may decrease energy consumption as described herein.

At 407, energy management application 504 generates reconfiguration instructions to reconfigure energy systems to increase or decrease in energy use by the energy consumer. For example, the parameters set in control panel 573 may be stored in datastore 508. If the energy manager indicates, or the system determines automatically, that the additional available energy has been acquired, then energy management application 504 may access the saved parameters for the energy utilization scenario, which includes parameters for each particular energy system. The parameters for each system are sent to the control blocks to configure each energy system to perform as simulated.

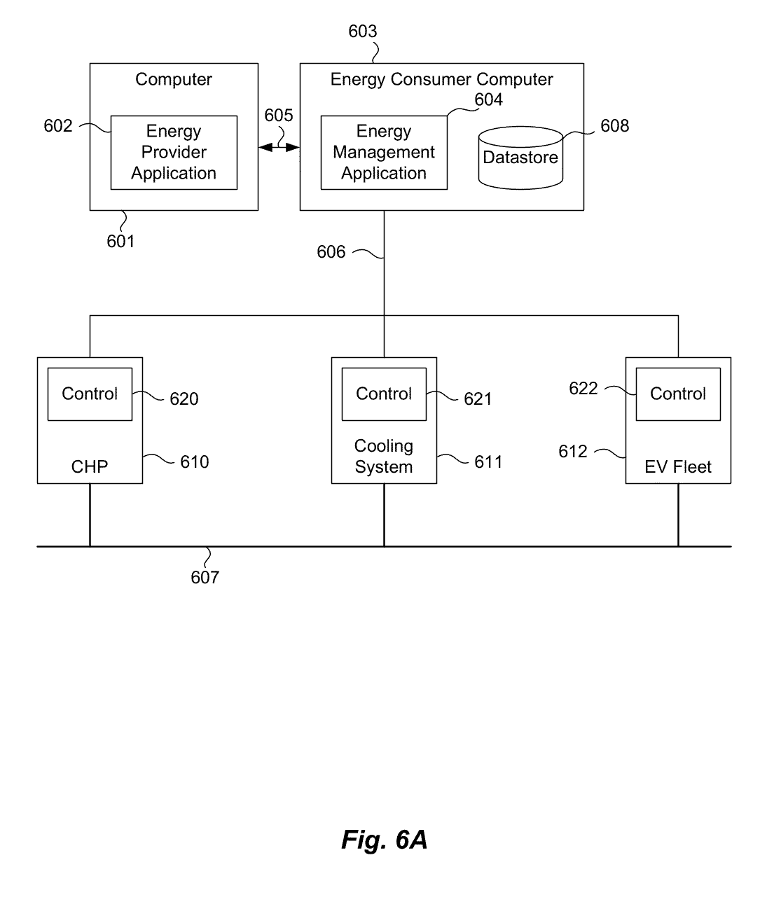

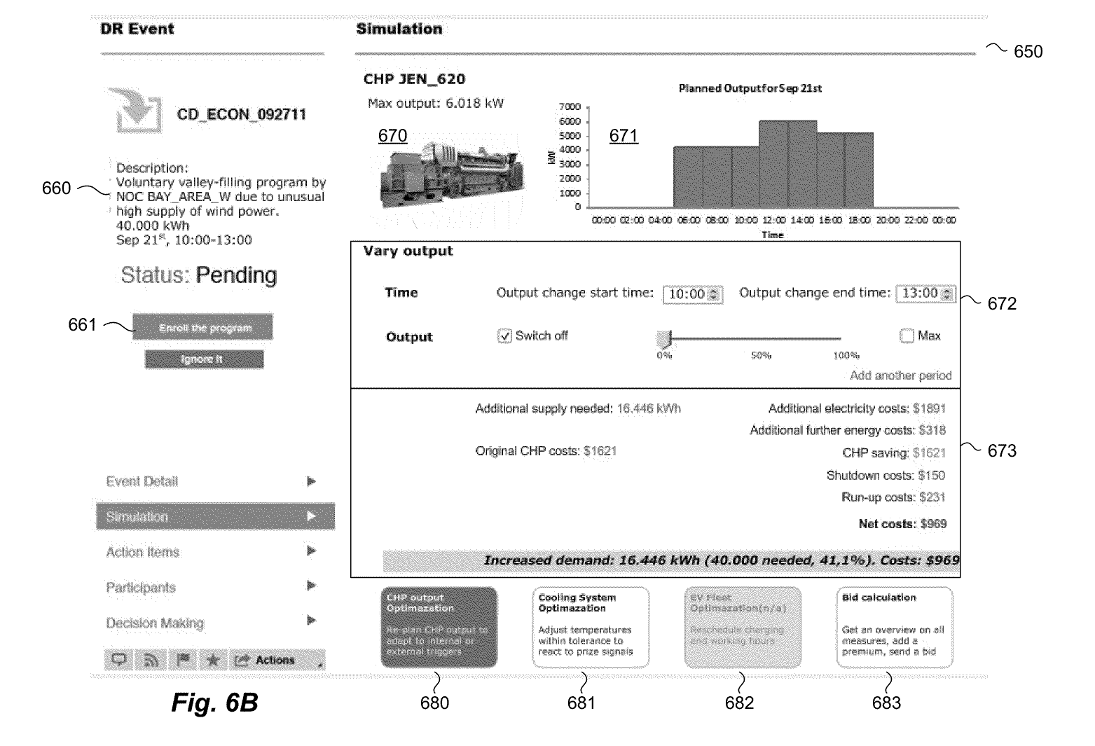

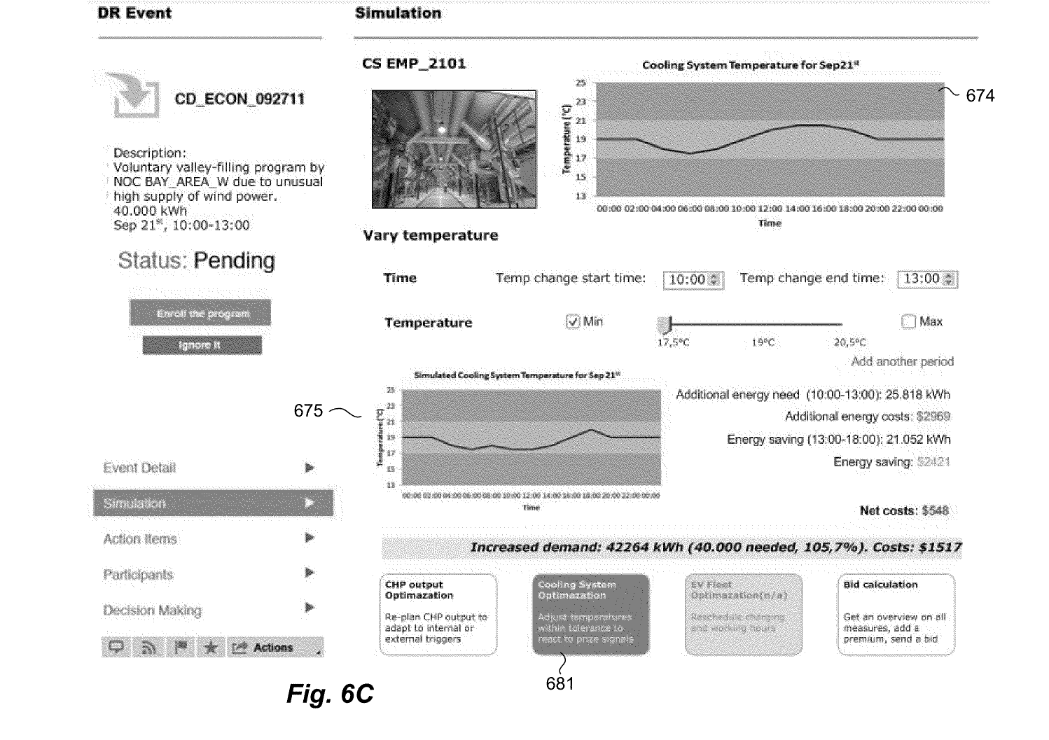

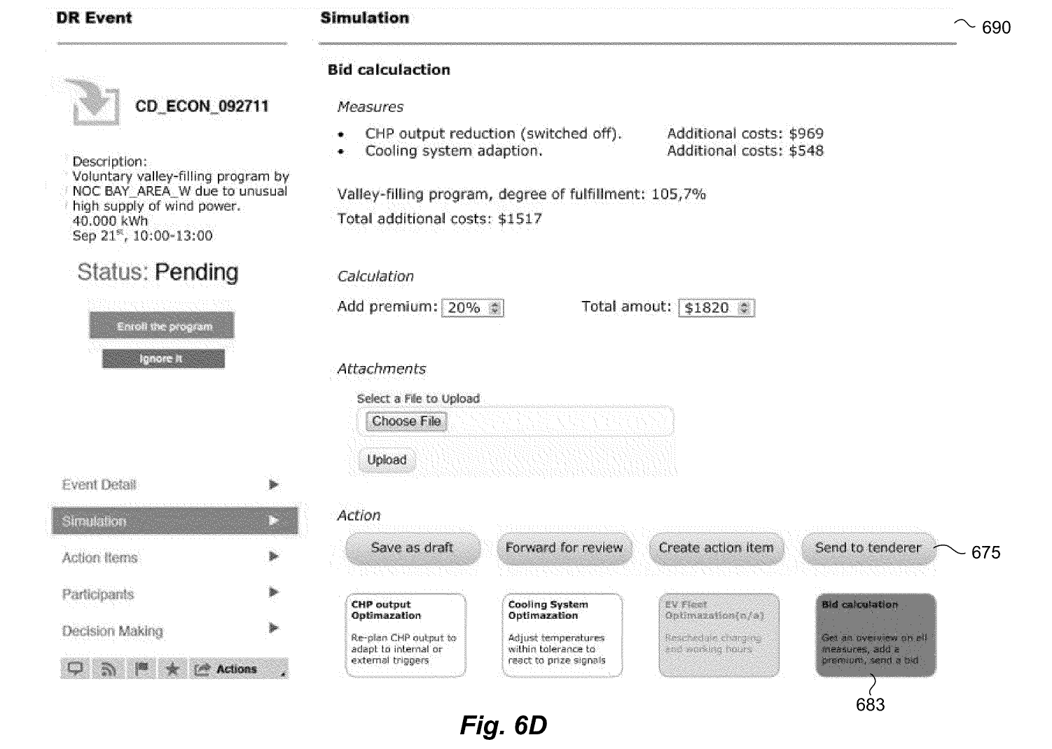

A detailed example of how modified parameters are transformed into a cost model is provided in FIGS. 6A-D below.

FIG. 6A illustrates a hardware configuration for an example implementation according to one embodiment. An energy provider may have one or more computers 601 that execute a software application 602 that may generate and send messages over a network 605 (e.g., the Internet) to an energy consumer's computer 603. Computer 603 executes an energy management application 604 that may send/receive messages to/from energy provider computer 601. Computer 603 is coupled over a data network 606 to multiple energy systems 610-612 that receive and/or send power across energy distribution infrastructure 607. The energy systems in this example include a CHP system 610, cooling system 611, and EV fleet 612 (e.g., charging stations for electric vehicles). Energy systems 610-612 may include control blocks 620-622 with hardware and executable software to communicate information between each system and application 604, for example. Computer 603 may include a datastore 608 that receives and stores energy data from each energy system. Energy data may include historical and/or planned energy data. The present example uses three energy systems to illustrate some of the concepts, but it is to be understood that fewer or additional systems could also be used.

FIG. 6B illustrates an example user interface according to one embodiment. In this example, an energy provider has 40,000 kWh of wind energy available on September 21^{st} between 10:00 and 13:00 as illustrated at 660. A user has selected the CHP system link 680, which causes the energy management application to access and display CHP information at 670, planned output data over the time period at 671, control parameters for the CHP at 672, and a cost model with automatically updated cost data at 673. To accept the available 40,000 kWh of wind power, the energy consumer must reconfigure their energy systems to increase the amount of energy used between 10:00 and 13:00 by 40,000 kWh. In this example, the CHP, which produces energy locally, is turned off (the “switch off” button is checked). As illustrated at 673, this increases the energy used by the energy consumer by 16,446 kWh. The cost model for the CHP may include an additional electricity cost (the cost of purchasing the 16,446 kWh at normal terms of an energy contract price without an incentive), an original CHP cost (the energy cost that would have been incurred if the CHP was not turned off), a CHP savings (the amount saved by turning off the CHP), shutdown costs (the cost to turn off the CHP), run-up costs (the cost of turning on the CHP), and a net cost (the net cost of turning off the CHP and using the wind energy available from the energy provider). In this example, with the CHP shut down between 10:00 and 13:00, the cost data for the CHP cost model is automatically calculated as shown in FIG. 6B, with an increased demand of 16,446, which is 41.1% of the total available 40,000 kWh of wind energy, at a net cost of $969. The user may now select and reconfigure other energy systems, to simulate allocating the total additional energy across other areas.

FIG. 6C illustrates the selection of cooling system link 681, which causes the energy management application to access and display cooling system information, including planned output data over the time period at 674. In this example, the planned output data around the time period when the additional wind energy is available is temperature over time. The cooling system may sense temperature and maintain the temperature at a particular value between above a minimum value and below a maximum value. The temperature value may be set using a slider as shown, for example. The planned output data illustrates that the energy consumption of the cooling system may be configured to initially cause the temperature to drop (between 02:00 and 09:00), then rise (between 09:00 and 15:00), and then drop again (between 15:00 and 20:00). Generally, there may be some kind of planning algorithm that tries to minimize costs depending on a dynamic energy tariff. A planned usage may be given, and the system may change the curve by trying to consume more energy in the timeslot given while maintaining the minimum and maximum constraints. In this example, in order to use the available wind energy, of which only 16,446 kWh was consumed by turning off the CHP, the cooling system may be turned on between 10:00 and 13:00 to consume an additional 25,818 kWh, and thereby bring the total amount of additional energy used by the energy consumer to 42,264 kWh over the specified time period. Modified planned energy data (e.g., in this case temperature) is illustrated at 675, which shows the variation in temperature (simulated) resulting from the use of 25,818 kWh in the cooling system between 10:00 and 13:00. The cost model for the cooling system includes additional energy used and a corresponding cost, energy saved and a corresponding cost, and a net cost. The energy management application determines the total energy used by all the energy systems (e.g., 42,264 kWh), the total cost (e.g., $1517), and may indicate to a user that the total additional available energy (40,000 kWh of wind energy) has been successfully allocated across the available energy systems accessible by the energy management application. In this example, an EV Fleet simulator may be available, but is not accessed because the total energy available has been allocated.

FIG. 6D illustrates a bid calculation interface 690 for one example embodiment. In this example, a user may select bid calculation link 683 to access interface 690. Energy management application 604 may summarize the net costs for each energy system configuration. In this example, a user may be able to add a premium to increase the incentive for consuming the additional energy. For instance, here, the sum of net costs is $1517. A user may add a 20% premium to produce a marked up amount of $1820, for example. Energy management application 604 may include a mechanism for automatically generating a response to the energy provider, where the response includes the total cost, including an optional mark-up, the energy consumer is required to receive to consume the additional available energy. The total cost corresponds to the total net cost of an energy utilization scenario simulated across multiple energy systems under control of the energy management system as described above. A “Send to Tenderer” link 675 is provided to automatically send an offer, including the marked up price, to the energy provider. If the energy provider accepts the offer from the energy consumer, the energy management system causes the simulated parameters to be implemented across the specified time period, and the demand is thereby shifted and the additional energy available during the specified time period is thereby consumed.

In some embodiments, the energy consumer may reduce the amount of energy they receive from an energy supplier. For example, an energy manager may receive an alert that energy expenses for a particular day are too high. The energy manager may review consumption forecasts and dynamic energy prices for that specific day. If a photovoltaic forecast, for example, is low, then energy prices may rise. Some embodiments may include an energy manager reviewing operations, and adjusting operations to lower energy consumption. In one embodiment, energy management application may be used to access operational activities for an energy consumer. The operational activities may have associated time periods, such as start times and end times, for example, as well as projected energy consumption levels. The energy management application may be used to change the time periods during which selected activities are performed, thereby shifting energy consumption levels away from time periods when renewable energy sources may be low and/or demand is high, for example. In the example below, an energy manager may use the energy management application to view a shop floor forecast for a day in detail. If particularly energy intensive manufacturing equipment is planned on being operated during a time period when energy prices are increasing due to a shortfall of wind power, for example, the energy manager may coordinate with a plant manager to shift particular activities to other times of the day.

For example, the energy management application may receive a forecast alert from an energy provider. An example alert may be as follows:

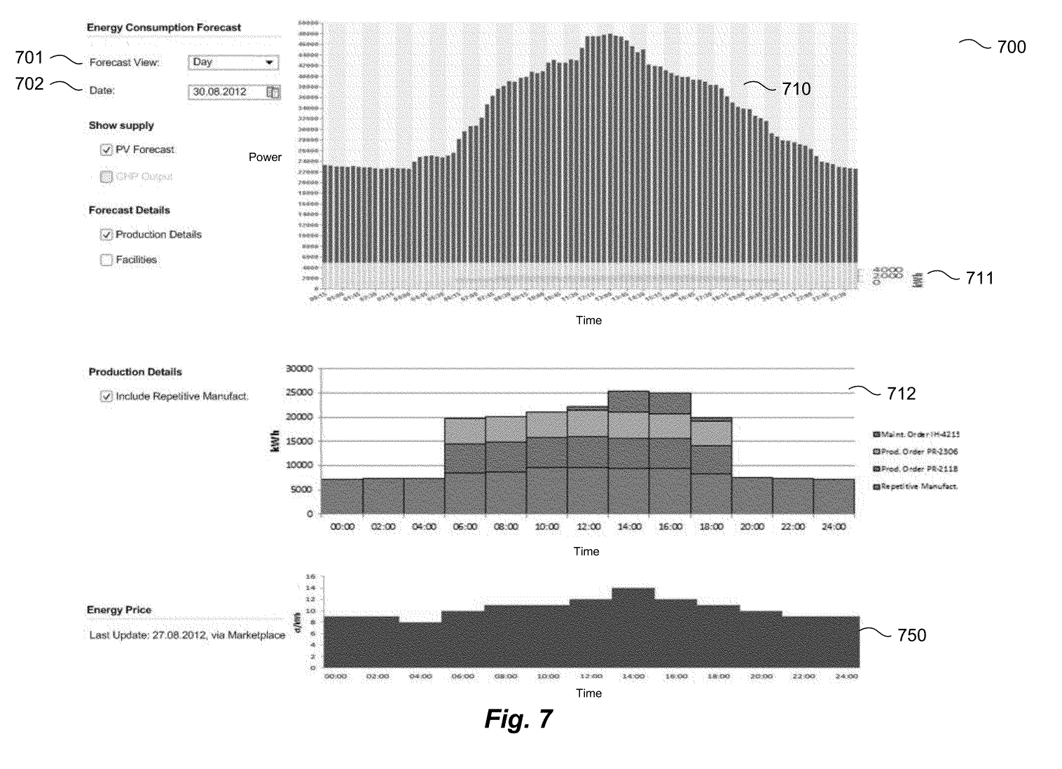

“Forecasted Energy Expenses for August 30 exceed average of last 4 weeks by more than 10%. Corresponding additional cost $712.58.”
Energy management system may retrieve forecast energy data and display the energy data to an energy manager. FIG. 7 illustrates an example of energy data in an energy management application according to another embodiment. Energy management application may present a user with an interface 700 for analyzing energy data. In this example, a user of the energy management application may select a day view 701 for a particular date 702. Energy management application may retrieve and display energy consumption forecast data 710 and energy cost data 750 (e.g., dollars/kWh). A user may select the “Show supply” “PV Forecast” button, which may cause the energy management application to retrieve and display forecasted photovoltaic energy output data 711, which may be energy generated locally by a PV energy system, for example. A user may select other energy supply systems to retrieve and display other local energy sources, such as a CHP system, for example.

Interface 700 further includes features to select, retrieve, and display energy consumption forecast data. For example, a user may select “Production Details,” which causes the energy management application to retrieve and display production energy data 712, for example. Energy production data 712 may be associated with particular activities. In this example, particular data is associated with particular orders (e.g., order numbers) or repetitive manufacturing. In this example, it may be desirable to shift Maint. Order IH-4215 away from the peak energy demand time period. A user may send a message to a production manager, for example, to cause the energy demand to shift to another time period. In one embodiment, an application may retrieve and display forecast energy utilization data associated with different activities having associated time periods. The application may receive a selection of one or more of the activities and change the time period to change the time when the selected activity consumes energy.

### EXAMPLE HARDWARE

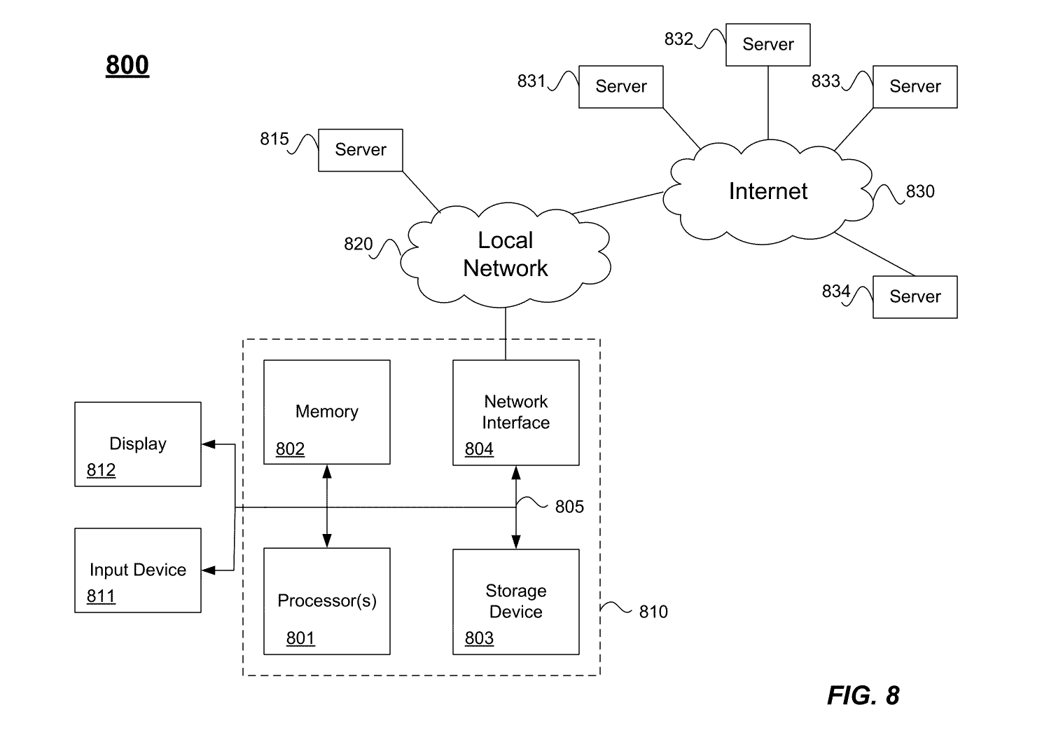

FIG. 8 illustrates hardware of a special purpose computing machine configured with a process according to one embodiment of the present invention. The following hardware description is merely one example. It is to be understood that a variety of computers topologies may be used to implement the above described techniques. An example computer system 810 is illustrated in FIG. 8, which shows components of a single computer. Computer system 810 includes a bus 805 or other communication mechanism for communicating information, and one or more processor(s) 801 coupled with bus 805 for processing information. Computer system 810 also includes a memory 802 coupled to bus 805 for storing information and instructions to be executed by processor 801, including information and instructions for performing the techniques described above, for example. This memory may also be used for storing variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 803 may include source code, binary code, or software files for performing the techniques above, for example. Storage device and memory are both examples of non-transitory computer readable storage mediums.

Computer system 810 may be coupled via bus 805 to a display 812 for displaying information to a computer user. An input device 811 such as a keyboard and/or mouse is coupled to bus 805 for communicating information and command selections from the user to processor 801. The combination of these components allows the user to communicate with the system. In some systems, bus 805 may be divided into multiple specialized buses.

Computer system 810 also includes a network interface 804 coupled with bus 805. Network interface 804 may provide two-way data communication between computer system 810 and the local network 820. The network interface 804 may be a digital subscriber line (DSL) or a modem to provide data communication connection over a telephone line, for example. Another example of the network interface is a local area network (LAN) interface to provide a data communication connection to a compatible LAN. Wireless links are another example. In any such implementation, network interface 804 sends and receives electrical, electromagnetic, or optical signals that carry digital data streams representing various types of information.

Computer system 810 can send and receive information through the network interface 804 across a local network 820, an Intranet, or the Internet 830. For a local network, computer system 810 may communicate with a plurality of other computers, such as server 815. One example implementation may include an energy management application executing on a server 815 and a user interfacing with the application on a computer 810. In the Internet example, software components or services may reside on multiple different computer systems 810 or servers 831-835 across the network for managing energy at a single facility or across multiple facilities. The processes described above may be implemented on one or more local or remote servers, for example. A server 831 may transmit actions or messages from one component, through Internet 830, local network 820, and network interface 804 to a component on computer system 810. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
receiving, in a computer executing an energy management application, energy information indicating an excess or deficiency of available energy for consumption by an energy consumer during a particular time period;
generating, in the computer executing the energy management application, one or more energy utilization scenarios, wherein each energy utilization scenario models how energy is consumed by one or more energy utilization systems under control of the energy management application over said time period;
generating, in the computer executing the energy management application, cost data based on each of the one or more energy utilization scenarios; and
generating reconfiguration instructions, in the computer executing the energy management application, to reconfigure one or more of the energy utilization systems to increase or decrease energy use by the energy consumer.

2. The method of claim 1 wherein different energy utilization systems have different cost models, and wherein particular configurations of a particular energy utilization system are automatically translated into cost data for a particular cost model associated with the particular energy utilization system.

3. The method of claim 2 further comprising:
displaying the energy utilization systems to a user;
receiving a selection of a particular energy utilization system;
accessing control parameters for the particular energy utilization system;
receiving modifications to the control parameters from a user; and
generating cost data, based on the modifications to the control parameters, for a particular cost model for the particular energy utilization system,
wherein the cost data represents a cost associated with a change in energy consumption by the energy consumer caused by the modifications to the control parameters.

4. The method of claim 1 wherein the received energy information indicates a particular amount of additional available energy during the particular time period, and wherein the particular amount of additional available energy is allocated across a plurality of said energy utilization systems, and wherein each energy utilization system has an associated additional energy consumption and net cost, wherein additional energy consumption and net cost of the energy utilization systems are aggregated to produce a total additional energy that is greater than or equal to said particular amount of additional available energy and an associate total cost.

5. The method of claim 4 further comprising sending a message to an energy provider offering to consume the additional available energy.

6. The method of claim 1 wherein the received energy information indicates a reduction in available energy during the particular time period, the method further comprising:
retrieving, in a computer executing an energy management application, data corresponding to a plurality of activities, the data indicating an amount of energy consumed by each of the plurality of activities and a time period associated with each of the plurality of activities;
sending the data for display to a user; and
receiving a selection of one or more of said activities and a change in the time period associated with the selected activities to change the time period when particular activities consume energy.

7. A system comprising:
one or more processors; and
a non-transitory computer readable medium having stored thereon program code, which when executed by the processor, causes the processor to:
receive energy information indicating an excess or deficiency of available energy for consumption by an energy consumer during a particular time period;
generate one or more energy utilization scenarios, wherein each energy utilization scenario models how energy is consumed by one or more energy utilization systems under control of the energy management application over said time period;
generating cost data based on each of the one or more energy utilization scenarios; and
generating reconfiguration instructions to reconfigure one or more of the energy utilization systems to increase or decrease energy use by the energy consumer.

8. The system of claim 7 wherein different energy utilization systems have different cost models, and wherein particular configurations of a particular energy utilization system are automatically translated into cost data for a particular cost model associated with the particular energy utilization system.

9. The system of claim 8 wherein the program code further causes the processor to:
display the energy utilization systems to a user;
receive a selection of a particular energy utilization system;
access control parameters for the particular energy utilization system;
receive modifications to the control parameters from a user; and
generate cost data, based on the modifications to the control parameters, for a particular cost model for the particular energy utilization system,
wherein the cost data represents a cost associated with a change in energy consumption by the energy consumer caused by the modifications to the control parameters.

10. The system of claim 7 wherein the received energy information indicates a particular amount of additional available energy during the particular time period, and wherein the particular amount of additional available energy is allocated across a plurality of said energy utilization systems, and wherein each energy utilization system has an associated additional energy consumption and net cost, wherein additional energy consumption and net cost of the energy utilization systems are aggregated to produce a total additional energy that is greater than or equal to said particular amount of additional available energy and an associate total cost.

11. The system of claim 10 wherein the program code further causes the processor to send a message to an energy provider offering to consume the additional available energy.

12. The system of claim 7 wherein the received energy information indicates a reduction in available energy during the particular time period, wherein the program code further causes the processor to:
retrieve, in a computer executing an energy management application, data corresponding to a plurality of activities, the data indicating an amount of energy consumed by each of the plurality of activities and a time period associated with each of the plurality of activities;
send the data for display to a user; and
receive a selection of one or more of said activities and a change in the time period associated with the selected activities to change the time period when particular activities consume energy.

13. A non-transitory computer readable storage medium embodying a computer program for performing a method, said method comprising:
receiving energy information indicating an excess or deficiency of available energy for consumption by an energy consumer during a particular time period;
generating one or more energy utilization scenarios, wherein each energy utilization scenario models how energy is consumed by one or more energy utilization systems under control of the energy management application over said time period;
generating cost data based on each of the one or more energy utilization scenarios; and
generating reconfiguration instructions to reconfigure one or more of the energy utilization systems to increase or decrease energy use by the energy consumer.

14. The non-transitory computer readable storage medium of claim 13 wherein different energy utilization systems have different cost models, and wherein particular configurations of a particular energy utilization system are automatically translated into cost data for a particular cost model associated with the particular energy utilization system.

15. The non-transitory computer readable storage medium of claim 14, the method further comprising:
displaying the energy utilization systems to a user;
receiving a selection of a particular energy utilization system;
accessing control parameters for the particular energy utilization system;
receiving modifications to the control parameters from a user; and
generating cost data, based on the modifications to the control parameters, for a particular cost model for the particular energy utilization system,
wherein the cost data represents a cost associated with a change in energy consumption by the energy consumer caused by the modifications to the control parameters.

16. The non-transitory computer readable storage medium of claim 13 wherein the received energy information indicates a particular amount of additional available energy during the particular time period, and wherein the particular amount of additional available energy is allocated across a plurality of said energy utilization systems, and wherein each energy utilization system has an associated additional energy consumption and net cost, wherein additional energy consumption and net cost of the energy utilization systems are aggregated to produce a total additional energy that is greater than or equal to said particular amount of additional available energy and an associate total cost.

17. The non-transitory computer readable storage medium of claim 16, the method further comprising sending a message to an energy provider offering to consume the additional available energy.

18. The non-transitory computer readable storage medium of claim 13 wherein the received energy information indicates a reduction in available energy during the particular time period, the method further comprising:
retrieving, in a computer executing an energy management application, data corresponding to a plurality of activities, the data indicating an amount of energy consumed by each of the plurality of activities and a time period associated with each of the plurality of activities;
sending the data for display to a user; and
receiving a selection of one or more of said activities and a change in the time period associated with the selected activities to change the time period when particular activities consume energy.
